(19) United States
(12) Patent Application Publication
(10) Pub. No.: US 2006/0035747 A1
(43) Pub. Date: Feb. 16, 2006

(54) ELECTRIC MULTI-STAGE TRANSMISSION

(75) Inventors: Tadashi Takano, Mori-Machi (JP); Hisashi Kazuta, Mori-Machi (JP)

Correspondence Address: ERNEST A. BEUTLER, ATTORNEY AT LAW, 10 RUE MARSEILLE, NEWPORT BEACH, CA, 92660, US

(73) Assignee: KABUSHIKI KAISHA MORIC, Mori-Machi (JP)

(21) Appl. No.: 11/161,088

(22) Filed: Jul. 22, 2005

(30) Foreign Application Priority Data
Aug. 12, 2004 (JP) 2004-235381

(51) Int. Cl. B60K 41/04

(52) U.S. Cl. 477/34

(57) ABSTRACT

Several embodiments of vehicles having multi-speed transmissions that can be electrically shifted up or down and also manually shifted up or down without having to operate the electric shift operator.

### BACKGROUND OF THE INVENTION

The present invention relates to a multi-ratio transmission having, in addition to a manual range selector, an electric motor for effecting gearshift operation, and more particularly to an electric motor operated multi-ratio transmission for a vehicle such as a motorcycle.

It has been proposed to provide an electric multi-stage transmission in which the gearshift operation of a vehicle such as a four-wheeled automobile is automated by using an electric motor. Such electric multi-stage transmission is connected to a shift mechanism via a reduction gear mechanism having worm gears or spur gears. Therefore, when the shift mechanism is activated from the motor, it requires only a small force corresponding to the reduction gear ratio and the actual shifting of the transmission is effected by the electric motor. However, a large and often an impossible amount of force is required to activate the motor part from the shift mechanism part while the reduction gears are engaged because of the reversed effect of the reduction gears.

In such an automotive application, the motor used to operate the vehicle transmission is powered by the vehicle battery. In the case of automobiles, if the engine cannot be started due to an abnormality of the battery, such as low voltage, there is no problem, because there is no chance of using the transmission when the engine cannot be started. Thus the problem of operating the transmission is rectified by recharging or replacing the battery.

On the other hand, some vehicles have arrangements where the engine can be started manually even if the battery is too low to start the engine. For example vehicles such as motorcycles or the like are equipped with a foot-operated shift pedal and also may be provided with an electric shifted multi-stage transmission. With such arrangements, the engine can be started by a kick pedal or the like even when the battery is in the abnormal condition. However, the gearshift operation cannot be made while the gears of the electric multi-stage transmission are engaged because the electric power is required to effect the shift.

To permit manual operation in such an application a construction as shown in Japanese Published application JP-A-2002-250439 has been proposed. In this arrangement, an electrically operated transmission for a motorcycle is provided for a motorcycle equipped with a shift pedal. This arrangement discloses a clutch disengagement structure with an auto-release mechanism working in association with a transmission shift rod. Also, the transmission includes an arrangement that allows the shift pedal activation disabling the power transmission system when both the assist motor and the shift pedal are provided in combination. This arrangement, however, has a complicated structure, and is difficult to operate due to the switching operation required when the shift pedal is used.

Therefore it is a principal object of this invention to provide a multi-stage transmission with an electric motor for effecting gearshift operation, and which allows for the gearshift operation through a manual operation of the shift mechanism even though the reduction gear mechanism may still be engaged.

### SUMMARY OF THE INVENTION

This invention is adapted to be embodied in a transmission shift control for a multi speed transmission having gear changes controlled by a shift operator moveable in a transmission range corresponding to several transmission ratios A manual operator is moveable in a selection range corresponding to the several transmission ratio selection positions, each corresponding to a respective one of said transmission ranges. An electric motor operator is included and a coupling arrangement connects the electric motor operator and the manual operator to the shift operator for operation of the shift operator by selective operation of either of the manual operator or the electric motor operator without affecting the position of the non selected operator.

### BRIEF DESCRIPTION OF THE DRAWINGS

FIG. 1 is a side elevational view of a motorcycle as an example of a vehicle that embodies the invention.

FIG. 2 is an enlarged top plan view of a handlebar of the motorcycle shown in FIG. 1.

FIG. 3 is a block diagram of the components of the invention.

FIG. 4 is a top plan view with components broken away and shown in section illustrating an embodiment of the invention.

FIG. 5 is a sectional view taken along the line 5-5 in FIG. 4 and shows the reversible one way clutching mechanism.

FIGS. 6A, 6B and 6C are enlarged views looking in the same direction as FIG. 5 showing various conditions in the action of the reversible one-way clutching mechanism.

FIGS. 7A, 7B and 7C are enlarged views, in part similar to FIGS. 6A, 6B and 6C, showing other various conditions in the action of the reversible one-way clutching mechanism.

FIG. 8 is an enlarged side elevational view looking in the direction opposite to FIG. 1 and shows an embodiment of mounting the electric actuator according to the invention.

FIG. 9 is an enlarged side elevational view, in part similar to FIG. 8 and illustrates another embodiment of mounting the electric actuator according to the invention.

FIG. 10 is an enlarged side elevational view, in part similar to FIGS. 8 and 9 and illustrates a still further example of mounting the electric actuator according to the invention.

FIG. 11 is an enlarged side elevational view, in part similar to FIGS. 8, 9 and 10 and illustrates a still further example of mounting the electric actuator according to the invention and also illustrates how the manual actuator can be incorporated in the previously described embodiments.

FIG. 12 is a partial, exploded top plan view with parts shown broken away and illustrates another embodiment of the present invention.

FIG. 13 is a side elevational view of the structure shown in FIG. 12 and shows the coupling engaged.

FIG. 14 is a side elevational view, in part similar to FIG. 13 and shows the operation when the coupling is disengaged.

### DETAILED DESCRIPTION

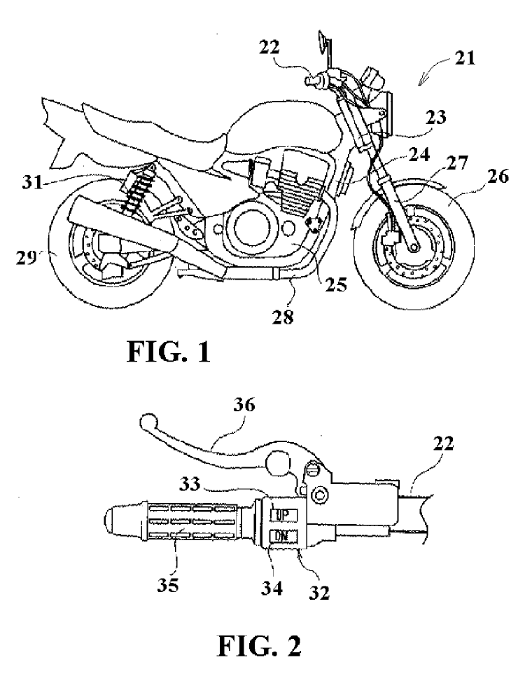

Referring now in detail to the drawings and first to FIG. 1, a motorcycle as an example of the type of vehicle to which the present invention may be applied is indicated generally by the reference numeral 21. Generally, except as will be hereinafter noted, the motorcycle 21 may have any known construction. The motorcycle has a steering shaft (not shown) to which handlebars 22 are affixed by means of a head pipe 23. The head pipe 23 is fixed in any desired manner to a front end of a cradle type main frame 24.

An engine 25 having an exhaust pipe 28 is suspended in any desired manner by the main frame 24 for driving of the motorcycle 21 in a manner as will be described shortly.

A front wheel 26 is dirigibly held and suspended by a front fork 27 with a built-in shock absorber (not shown). The main frame 24 is suspended at its rear end by a rear wheel 29 by a suspension system including a shock absorber 31. Therefore, the engine 25 suspended by the main frame 24 is supported by the front wheel 26 and the rear wheel 29 via the aforementioned shock absorber in the front fork 27 at the front part of the motorcycle body and the shock absorber 31 at the rear part of the motorcycle body. An electrically operated multi-ratio transmission driven by the engine 25 and operated according to this invention is positioned on the periphery of the engine 25 is supported by the main frame 24 along with the engine 25 in a manner that vibration is absorbed.

The manner in which the electrical shifting of the transmission is controlled will now be described by reference to FIG. 2 which is a top plan view of the handlebars 22 in accordance with an embodiment of the invention. This is comprised of an electric shift operator positioned in a finger-operated shift control area, indicated generally at 32, in which a gear-up switch 33 and a gear-down switch 34 is provided at the base of a handle grip 35. These switches 33, 34 are intended for actuating a shift mechanism via an electric actuator which will be described later. The reference numeral 35 denotes a clutch operating lever that is juxtaposed to the switches 33 and 34.

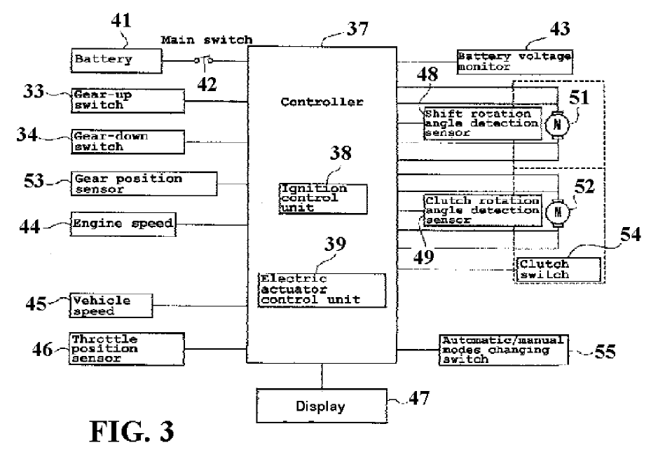

Referring now to the block diagram of FIG. 3, this shows the components of the electric multi-stage transmission and its control elements according to this invention as well as the relationship to related elements. This includes a controller, indicated generally by the reference numeral 37, which includes, among other things, an ignition control unit 38 and an electric shift actuator control unit 39. The controller 37 is connected to a battery 41 via a main switch 42. In addition, the controller 37 is connected to a battery voltage sensor 43 for detecting the voltage (capacity) of the battery. In addition, the controller 37 is connected to the gear-up switch 33, the gear-down switch 34, an engine speed sensor 44, a vehicle speed sensor 45, a throttle position sensor 46, a condition display meter 47, a shift rotation angle sensor 48, a clutch rotation angle sensor 49, a shift motor 51, a clutch motor 52, a gear position sensor 53 for detecting the shift position, a clutch switch 53 for detecting the clutch engagement and disengagement, and an automatic/manual mode changing switch 55. The structures of these components and their operation will be described shortly.

For example, the automatic/manual modes changing switch 55 is a switch for selecting the shift control using either the electric actuator (automatic) or the shift control by the foot operation of the shift pedal (manual and to be described). When the automatic mode is selected, gear shift operation is made by switching a finger-operation area 32 on the handle grip to effect a shift up or shift down operation by actuating the electric shift motor 51. Even while the automatic mode position is selected, shifting can also be made by the foot operation of the shift pedal, as will be described later. Thus, in some cases, the foot operation of the shift pedal may be used for changing the shift condition after the shifting is made by the shift motor 51. In such cases, the shift position recorded in the electric shift control unit 39 for controlling the operation of the shift motor 51 becomes inconsistent, and the gear shift might not be actuated properly the next time the electric shift is used. In this invention, such problem is addressed by detecting the shift position with a gear position sensor 53 and inputting the detected signal into the electric shift control unit 39, thus enabling the identification of the correct shift position at that moment, and allowing the proper shifting action based on the identified correct shift position.

The shift position detected by the gear position sensor 53 is indicated on the display meter 47 as a current shift gear position. Signals of the detected shift position is sent to the electric actuator control unit 39 for actuating the shift motor 51 of the electric actuator at the optimum shift speed depending on the shift position.

When the manual shift is selected, the gear-up switch 33 and the gear-down switch 34 located at the root of the handle grip, as well as the shift motor 51 is shut off, deactivating the electric actuator and inhibiting the motor from being actuated by the finger-operated shift control. In such cases, the shifting can be made only by the foot operation of the shift pedal as will also be described.

Signals detected by the engine speed sensor 44 for detecting the rpm (revolutions per minute) of the crankshaft, the vehicle speed sensor 45 for detecting the running speed of the motorcycle, and the throttle position sensor 46 for detecting the throttle opening are input into the ignition control unit 38 are all accomplished in any known or desired manner. The ignition control unit 38 calculates an optimum ignition timing depending on the operating conditions determined by these detected signals, and controls the actuation of an ignition coil (not shown) in accordance with any desired control routine. Such operating conditions (engine speed, vehicle speed, and so on) are also displayed on the display meter 47.

The ignition control unit 38 is connected to the electric actuator control unit 39. The electric actuator control unit 39 in turn controls the operation of the electric shift motor 51 for gearshift operation in a manner to be described shortly. It also achieves smooth clutch action by reducing the engine output power at the time of clutch disengagement and engagement for the shifting, by retarding the ignition timing or by cutting the ignition to cause misfire.

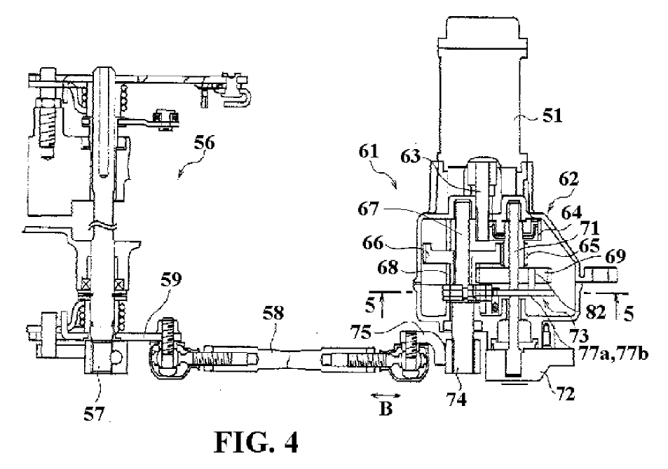

The electric actuator control unit 39 is connected to the clutch actuator which comprises the clutch position detecting sensor 49 for detecting the clutch condition, and a clutch motor 52 for actuating the clutch. The shift actuator is comprised of the shift rotation angle sensor 48 for detecting the position of a shift actuating shaft to be described later by reference to FIG. 4 and the shift motor 51 for actuating the shift mechanism shown in FIG. 4. The electric actuator control unit 39 is connected to the finger-operated shift control area 32 provided on the handle grip 35 as seen in FIG. 2. As has already been noted, the finger-operated shift control area 32 includes the gear-up switch 33 and the gear-down switch 34.

The electric actuator control unit 39 rotationally activates the shift motor 51 in the gear-up direction or in the gear-down direction based on the operation signal from the gear-up switch 33 or the gear-down switch 34, which activates the shift mechanism via a shift rod, as will be described by reference to FIG. 4 for the gearshift operation. As the gearshift operation is completed, the shift actuating shaft is returned to the neutral position by rotating the shift motor 51 in reverse. The rotation angles of the shift motor 51 relevant to its rotary motion to the shift position, or its rotary motion back to the neutral position (or the rotation angle of the shift actuating shaft corresponding to these rotary motions) are detected by the shift position detecting sensor 48. According to the detected rotation angles, the shift motor 51 is rotated definitely to the shift position and is always returned to the neutral position correctly after the shifting motion.

This actuating mechanism will now be described by reference to FIG. 4. This shift actuating mechanism is indicated generally by the reference numeral 56 wherein the transmission gear position is selected by the rotary motion of a shift selecting shaft 57. The gear shift is therefore activated to move into the selected gear shift position in stages in a manner well known in this art.

The shift selecting shaft 57 is pivotally connected to one end of a shift rod 58 via a lever 59. An electric actuator, indicated generally by the reference numeral 61, is pivotally connected in a manner to be described to the other end of the shift rod 58. The electric actuator 61 includes the shift motor 51, which may comprise a DC motor, and a reduction gear mechanism, indicated generally by the reference numeral 62, driven by the shift motor 51.

The gear formed end of a motor shaft 63 of the shift motor 51 engages the first gear 64 of the reduction gear mechanism 62. A second gear 65, which is coaxially disposed and integrally formed with the first gear 64, engages a third gear 66. The third gear 66 is journalled on a shaft 67 offset from the motor shaft 63. The third gear 66 is integrally connected with a coaxial fourth gear 68. The forth gear 68 is enmeshed with a fifth gear 69. The integral first and the second gears 64, 65 are journalled on a shaft 71 of the fifth gear 69. Thus the shaft 71 forms a common axis upon which the first and the second gears 64, 65 are journalled. Thus a compact gear structure is attained by utilizing the common shaft 71. The rotational speed of the motor shaft 63 on the shift motor 51 is reduced by means of the transmission just described comprised of first gear 64 through the fifth gear 69.

The rotational angle position of the shift motor 51 and specifically its shaft 53 is detected by a potentiometer 72 is provided at the lower end of the shaft 71 of the fifth gear 69. By detecting the rotation angle of the fifth gear 69 by the potentiometer 72, the corresponding rotation angle of the shift motor 51 can be determined. According to the determined angle, the shift motor 51 is activated to the rotation angle required for the desired gearshift operation. In addition, using the potentiometer 72 enables the exact determination of the neutral position when the shift motor 51 is returned to the neutral position by reversing the shift motor 51 rotation after the shifting. If a brush-less motor is used as the shift motor 51, a magnetic pole position detecting sensor can be used to detect the rotation angle of the motor, as such sensor is incorporated in the motor. Thus, the separately mounted potentiometer 72 can be omitted when the brush-less motor is used.

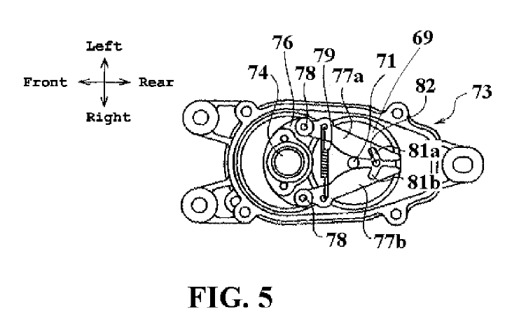

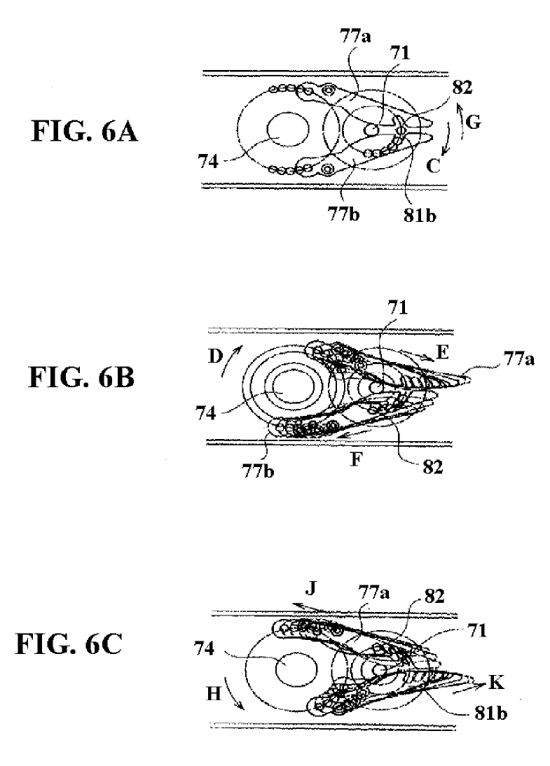

A reversible one-way transmission mechanism, indicated generally by the reference numeral 73 and shown in more detail in FIGS. 5, 6A-C and 7A-C, is provided for engagement with the fifth gear. The one-way transmission mechanism 73 effects rotary motion of a shift actuating shaft 74 (the output shaft of the electric actuator 62) for activating the shift mechanism 56 in accordance with the rotary motion of the fifth gear 69. However when an opposite force (the torque exerted on the shift actuating shaft 74 via the shift rod 58 when the shifting motion of the shift mechanism 56 is caused by the shift pedal, for example), the one-way transmission mechanism 73 works to prohibit any force from being exerted on the fifth gear 69 and thus manual operation is possible without having to overcome the high load required to rotate the electric motor 51 through the high ratio reduction gear mechanism 62.

The end portion of the shift rod 58 is joined to the shift actuating shaft 74 via an actuating lever 75. This provides a spherical connection to the shift rod 58 for operating the shift selecting shaft 57. The rotary motion of the shift actuating shaft 74, which is actuated rotationally by the shift motor 51 via the reversible one-way transmission mechanism 73 as aforenoted, generates a linear motion of the shift rod 58 as indicated by arrow B via the actuating lever 75. This linear motion causes the rotation of the shift selecting shaft 57 via the lever 59 joined to the opposite end of the shift rod 58. Thus, the shift mechanism 56 activates the gearshift operation.

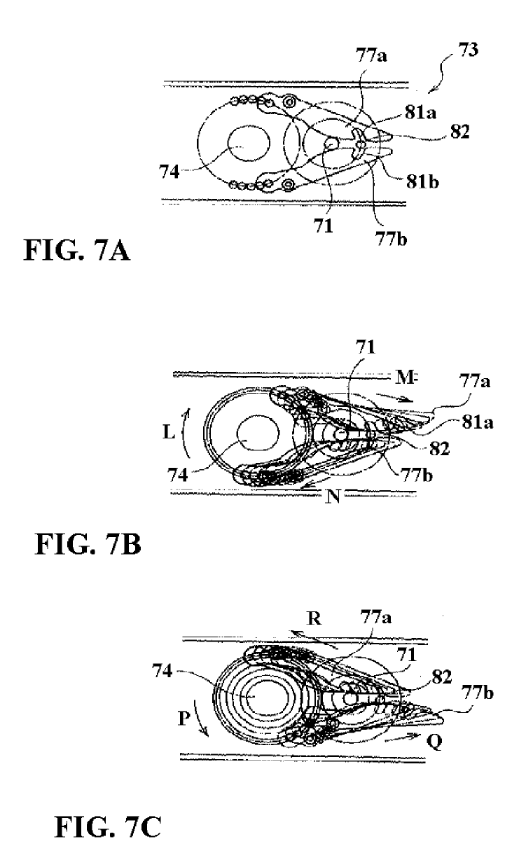

The structure of the reversible one-way transmission mechanism will now be described in detail by reference to FIG. 5 while its reversible one way operation will later be described by reference to FIGS. 6A-6C and 7A-7C. A bellcrank 76 is fastened to the shift actuating shaft 74. Lever arms 77a, 77b are pivotally connected the left end and the right end of the bellcrank 76, respectively, by pivot shafts 77. The lever arms 77a, 77b are urged together by means of a tension spring 79 to engage the shaft 71. FIG. 5 illustrates the neutral position (the condition in which the motor 51 has returned to the initial position after the gearshift operation is completed).

A respective cutout groove 81a, 81b is formed on each lever arm 77a, 77b at a position facing a pin 82 provided on the fifth gear 69. The cutout grooves 81a, 81b are formed along the arc about which the pin 82 makes its rotary motion when the fifth gear 69 rotates. The length of the cutout grooves 81a, 81b along this arc forms a lost motion connection for the pin 82 before it presses and activates the lever arms 77a, 77b. Discrepancies of parts dimensions and parts assembly are canceled by the lost motion, thus the shift actuating shaft 74 always starts to rotate at the given distance from its neutral position.

Therefore, when the rotation angle of the shift motor 51 controls the actuation of the shift mechanism, the motor's rotation angle required to make the shifting is calculated at high accuracy regardless of the dimensional discrepancies and other relevant factors, resulting in a stable and highly accurate electrical shift control.

The operation of the reversible one-way transmission mechanism 73 will now be described by reference to FIGS. 6A-6C and FIGS. 7A-7C. When the pin 82 rotates around with the shaft 71 in forward or reverse directions (C or G in FIG. 6A) following the rotation of the fifth gear 69. Then the pin 82 will move into the cutout groove 81a, 81b on either of the lever arms 77a or 77b to pivot the relevant lever arm 77a or 77b, causing the bellcrank 76 to rotate via the connecting shaft 77. In this way, the shift actuating shaft 74 fixed to the bellcrank 76 makes its rotation.

FIGS. 6A-6C illustrate the operation of the reversible one-way transmission mechanism 73 when the electric shifting is activated. FIG. 6A indicates the neutral condition as shown in FIG. 5. In shifting in a gear-up action from this condition, as seen in FIG. 6B, the pin 82 rotates in the direction of an arrow C, making its way into the cutout groove 81b on the lever arm 77b eventually reaches the end of the groove 81b. Upon continued movement, the pin 82 presses the lever arm 77b to move it forward as indicated by an arrow F. Simultaneously, the opposite lever arm 77a moves rearward as indicated by an arrow E with its inner edge sliding along the shaft 71. Due to such motion of the lever arms 77a, 77b, the bellcrank 76 (see FIG. 5) rotates in the direction of an arrow D, causing the shift actuating shaft 74 to rotate in the same direction as indicated by the arrow D. Thus, the shift mechanism 56 shown in FIG. 4 effects the gear-up action via the shift rod 58.

In the gear-down action from the neutral condition shown in FIG. 6A, the pin 82 rotates in the direction of an arrow G, making its way into the cutout groove 81 a on the lever arm 77a and eventually hits the end of the groove 81a. Subsequently and as shown in FIG. 6C, the pin 82 presses the lever arm 77a to move it forward as indicated by an arrow J. Simultaneously, the opposite lever arm 77b moves rearward as indicated by the arrow K with its inner edge sliding across the shaft 71. According to such motion of the lever arms 77a, 77b, the bellcrank 76 (see FIG. 5) rotates in the direction of an arrow H, causing the shift actuating shaft 74 to rotate in the same direction. Thus, the shift mechanism 56 shown in FIG. 4 makes the gear-down action via the shift rod 58.

Referring now to FIGS. 7A-7C, these views illustrate an operation of the reversible one-way transmission mechanism when the manual shifting is activated and how the mechanism is unclutched from the reduction gear transmission 62. Again FIG. 7A indicates the neutral condition. If a shift pedal (as to be described later) is activated by the foot operation to cause the gear-up action of the shift mechanism 56 as seen in FIG. 4, the shift actuating shaft 74 will be rotated in the direction of an arrow L as shown in FIG. 7B via the shift rod 58 shown in FIG. 4. Thus, the lever arms 77a, 77b move in the directions of arrows M and N respectively via the bellcrank 76 as seen in FIG. 5. In this moving process, lever arms 77a, 77b are maintained in sliding contact with the shaft 71, and do not rotate inwardly from their neutral positions shown in FIG. 7A. Therefore, neither of the cutout groove 81a, 81b engage with the pin 82 while the lever arms 77a, 77b are moving. Therefore, the shift actuating shaft 74 can be rotated without driving engagement with the reduction gear mechanism of the electric actuator to which the pin 82 is fixed. As a result, when the shifting is made by the foot operation of the shift pedal, the force from the foot operation, which otherwise would have been transmitted to the electric actuator via the shift rod, is avoided, and the foot operation can be made with usual shift-pedal operating force without receiving any reaction force from the electric actuator or the step down transmission 62.

As seen in FIG. 7C, the same condition exists with manually actuated gear-down action. Similar to the gear-up action shown in FIG. 7B, the gear-down operation is made in a similar manner. That is, when the shift actuating shaft 74 is rotated in the direction of an arrow P, the lever arms 77a, 77b move to the directions of arrows R and Q respectively without engagement with the hook pin 82. Thus, similar to the gear-up action, when the shifting is made by the foot operation of the shift pedal, the force from the foot operation, which would have been transmitted otherwise to the electric actuator via the shift rod, is avoided, and the foot operation can be made with usual shift-pedal operating force without receiving any counterforce from the electric actuator.

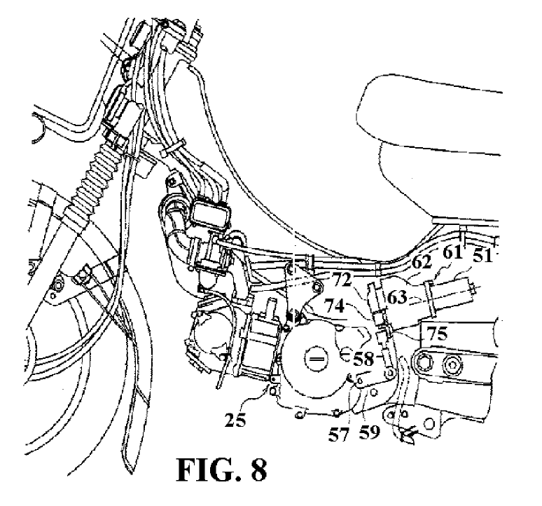

In addition to the foregoing advantages, the construction described lends itself to ready adaptation to a wide variety of vehicles having different engine, frame and transmission arrangements. For example FIG. 8 shows one type of mounting the electric shift actuator. In this example, the electric actuator is disposed above and to one side of a horizontally disposed engine 25 of a motorcycle. The shift mechanism (not shown) is provided inside of the housing of the engine 25, and the shift selecting shaft 57 of the shift mechanism projects at one side of the engine 25. The electric actuator 61 is disposed so that the motor shaft 63 of the shift motor 51 and the shift actuating shaft 74 extend in parallel relationship and are skewed relative to the shift selecting shaft 57.

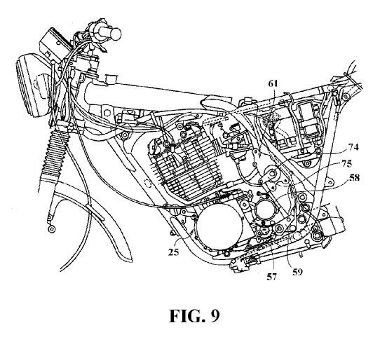

FIG. 9 shows another example of mounting the electric actuator in a motorcycle wherein the engine 25 is mounted in a generally vertical orientation. The electric actuator 61 in this example is disposed at the rear of the engine 25 and extends transversely of the frame. Thus the shift actuating shaft 74 and the motor shaft (not shown) extend in parallel The shift actuating shaft 74 is positioned in parallel with the shift selecting shaft 57. Similar to the example shown in FIG. 4, the shift selecting shaft 57 is joined to the shift rod 58 via the lever 59, and the shift rod 58 is joined to the shift actuating shaft 74 via the actuating lever 75.

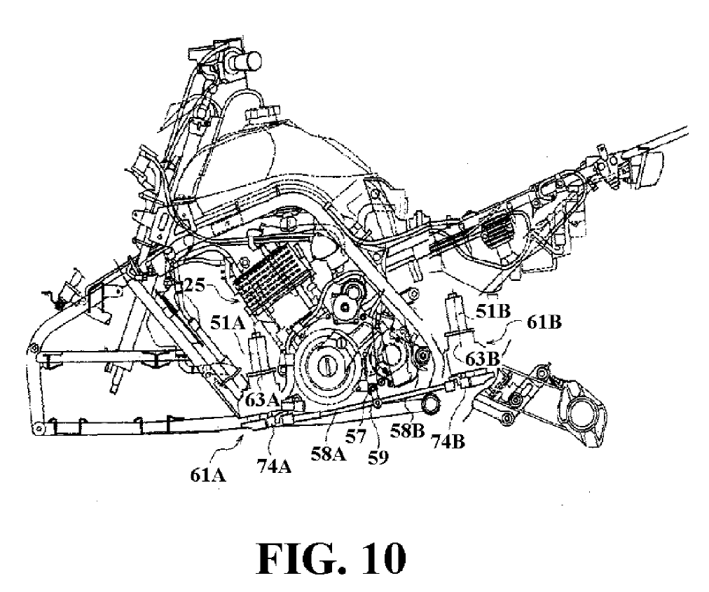

FIG. 10 shows a further example of two different mounting an electric actuator on an ATV (All Terrain Vehicle) such as a dune buggy. Either the electric actuator is provided in front of the engine 25 as shown at 61A or at the rear as shown at 61B. In either case, the electric actuator 36A or 36B is joined to the shift selecting shaft 57 via the shift rod 58A or 58B respectively. In these examples of the mounting, the electric actuator 36A or 36B is disposed so that the motor shaft 63A or 63B of the shift motor 51A or 51B and the shift actuating shaft 74A or 74B are parallel with the respective motor shaft 63A or 63B are in the skewed position relative to the shift selecting shaft 57.

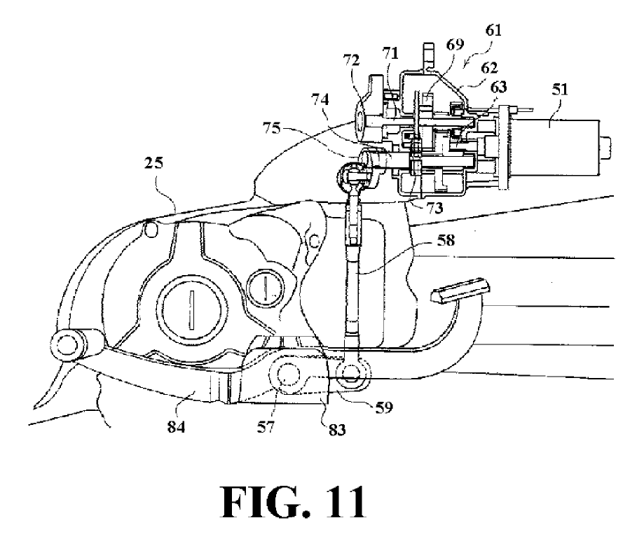

Reference has been made to the shift pedal for effecting the manual shifting, however in the figures aforedescribed it has not been shown. A showing of a mechanism of this type will now be described by reference to FIG. 11 which shows the arrangement of the shift pedal and the electric actuator 61 in a vehicle having a configuration and actuator location similar to that shown in FIG. 8. Of course from the following description those skilled in the art will readily understand how a manual shift mechanism of any desired type can be used with the invention as described.

Referring now in detail to FIG. 11 many of the components as already described are shown and in that case they have been identified by the reference numerals previously utilized and will be described again only where necessary to understand this embodiment. A foot rest 83 is provided at the left side of the engine 25. A shift pedal 84 is fixed to the end of the shift selecting shaft 57 which projects from the side face of the engine 25 behind the foot rest 83. The lever 59 is fixed to the shift selecting shaft 57 at the location between the shift pedal 84 and the side face of the engine. One end of the shift rod 58 is joined to the end of the lever 59. Similar to the aforementioned arrangement (FIG. 4), the other end of the shift rod 58 is joined to the shift actuating shaft 74 of the electric actuator 61 via the actuating lever 75.

As described earlier, once the electric actuator 61 is activated, the shift actuating shaft 74 is rotated via the reversible one-way transmission mechanism 73, which in turn moves the shift rod via the actuating lever 75. This causes the shift selecting shaft 57 to rotate via the lever 59, and the gearshift operation is made by the shift mechanism 56 (FIG. 4). When the shift selecting shaft 57 rotates, the shift pedal 84 fixed to the shift selecting shaft 57 rotates as well.

On the other hand, foot-operation of the shift pedal 84 causes the rotation of the shift selecting shaft 57 fixed to the foot pedal, and the gearshift operation is made by the shift mechanism 56 (FIG. 4). In this process, the foot-operation force is transferred to the electric actuator part via the lever 59 and the shift rod 58. However, this force is isolated by the reversible one-way transmission mechanism 73 as described above, and the gearshift operation using the shift pedal 84 is carried out smoothly without operating the electric actuator 61.

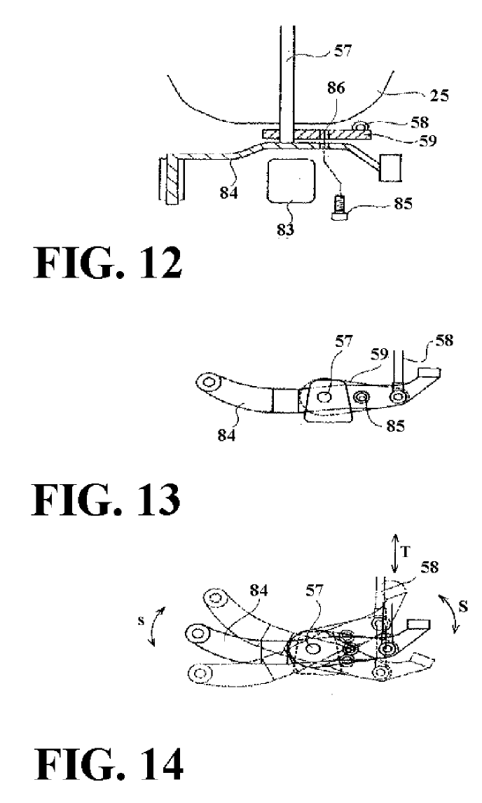

In all of the embodiments thus far described the transition between electrical and manual shifting has been accomplished automatically due to the incorporation in the connection between the respective actuators and the shift control shaft 57 of the reversible one way clutch 73. Although this has the advantage of an automatic transition, in some instances a less costly arrangement may be desired. This is useful in situations where the transition between electric assist and manual shifting occurs less frequently. Such an embodiment will now be described by reference to FIGS. 12-14.

In this embodiment, the lever 59 is journalled for rotation on the shift selecting shaft 57. The shift pedal 84, on the other hand is fixed to the shift selecting shaft 57 and always rotates with it so that manual operation is always possible as long as it is uncoupled from the lever 59.

In order to permit electric shift action the lever 59 is coupled for rotation with the shift pedal 84 by a threaded fastener 85 that passes through an opening in the shift pedal and into a threaded opening 86 in the lever 59. In this condition, as the shift rod 58 is moved in the direction of an arrow T by activating the electric actuator as shown in FIG. 14, the lever 59, rotates in the direction of an arrow S, making the shift selecting shaft 57 rotate to effect the gearshift operation.

To return to gear shift by foot-operation of the shift pedal 84, the lever 59 and the shift pedal 84 are disconnected each other by removing the threaded fastener 85. In this condition, as the shift pedal 84 is moved in the direction of the arrow s shown in FIG. 14, the shift selecting shaft 57 rotates to make the shifting action. However, because the bolt 58 is removed, the lever does not rotate with the shift pedal 84 but idly slips around the shift selecting shaft 57 without activating the shift rod 58. Therefore, the operating force of the shift pedal 84 is not transferred to the electric actuator part, and the foot-operation shifting is carried out smoothly and easily.

Thus it should be obvious that the present invention may be applied to a motorcycle or an ATV such as a dune buggy provided with an electric multi-stage transmission in which the step-by-step type multi-stage transmission is actuated by an electric motor and at the same time provided with a shift pedal for manual foot without having to effect rotation of the electric assist motor through a step down transmission. Of course those skilled in the art will readily understand that the described embodiments are only exemplary of forms that the invention may take and that various changes and modifications may be made without departing from the spirit and scope of the invention, as defined by the appended claims.

What is claimed is:

1. A transmission shift control for a multi speed transmission having gear changes controlled by a shift operator moveable in a transmission range corresponding to several transmission ratios, a manual operator moveable in a selection range corresponding to several transmission ratio selection positions each corresponding to a respective one of said transmission ranges, an electric motor operator, a coupling arrangement connecting said electric motor operator and said manual operator to said shift operator for operation of said shift operator by selective operation of either of said manual operator or said electric motor operator without affecting the position of the non selected operator.

2. A transmission shift control for a multi speed transmission as set forth in claim 1 wherein the coupling arrangement comprises a one way clutch.

3. A transmission shift control for a multi speed transmission as set forth in claim 2 wherein a single one way clutch permits either the manual operator or the electric motor operator to operate the shift operator without effecting a change in position of the other operator.

4. A transmission shift control for a multi speed transmission as set forth in claim 1 wherein the coupling arrangement comprises a connection that can be disabled.

5. A transmission shift control for a multi speed transmission as set forth in claim 4 where the connection that can be disabled is the connection between the electric motor operator and the shift operator.

6. A transmission shift control for a multi speed transmission as set forth in claim 1 wherein the electric motor operator is a reversible stepping motor.

7. A transmission shift control for a multi speed transmission as set forth in claim 6 wherein the coupling arrangement comprises a one way clutch.

8. A transmission shift control for a multi speed transmission as set forth in claim 7 wherein a single one way clutch permits either the manual operator or the electric motor operator to operate the shift operator without effecting a change in position of the other operator.

9. A transmission shift control for a multi speed transmission as set forth in claim 6 further including a manually operated electrical control for operating said reversible stepping motor in selected shift down and shift up modes to effect shifting of the transmission in shift down and shift up directions.

10. A transmission shift control for a multi speed transmission as set forth in claim 9 wherein the reversible shifting motor is returned to a home position after the transmission shift has occurred.

11. A transmission shift control for a multi speed transmission as set forth in claim 10 further including a potentiometer for indicating the position of a shaft associated with the reversible stepping motor.

12. A transmission shift control for a multi speed transmission as set forth in claim 11 wherein the reversible stepping motor drives the shift operator through a step down transmission.

13. A transmission shift control for a multi speed transmission as set forth in claim 1 wherein the manual operator comprises a pivotally supported lever.

14. A transmission shift control for a multi speed transmission as set forth in claim 13 wherein the electric motor operator is a reversible stepping motor.

15. A transmission shift control for a multi speed transmission as set forth in claim 14 wherein the coupling arrangement comprises a one way clutch.

16. A transmission shift control for a multi speed transmission as set forth in claim 15 wherein a single one way clutch permits either the manual operator or the electric motor operator to operate the shift operator without effecting a change in position of the other operator.

17. A transmission shift control for a multi speed transmission as set forth in claim 13 further including a manually operated electrical control for operating said reversible stepping motor in selected shift down and shift up modes to effect shifting of the transmission in shift down and shift up directions.

18. A transmission shift control for a multi speed transmission as set forth in claim 17 wherein the reversible shifting motor is returned to a home position after the transmission shift has occurred.

19. A transmission shift control for a multi speed transmission as set forth in claim 18 further including a potentiometer for indicating the position of a shaft associated with the reversible stepping motor and the reversible stepping motor drives the shift operator through a step down transmission.
